(19) United States
(12) Patent Application Publication
(10) Pub. No.: US 2007/0295824 A1
(43) Pub. Date: Dec. 27, 2007

(54) INTERIOR WARMING SYSTEM USING EXHAUST GAS SYSTEM

(75) Inventors: James C. Bradley, New Haven, IN (US); Anthony J. Cook, Fort Wayne, IN (US); Rodney J. Klinger, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(73) Assignee: International Truck Intellectual Property Company, LLC, Warrenville, IL (US)

(21) Appl. No.: 11/426,465

(22) Filed: Jun. 26, 2006

(51) Int. Cl. B60H 1/00

(52) U.S. Cl. 237/12.3 A

(57) ABSTRACT

A heating system for use on an exhaust system of a vehicle having an exhaust gas passageway to emit exhaust gases from an engine to an outlet includes a quasi black body heat collector. The heat collector is located on the exhaust gas passageway for capturing heat from the exhaust gases. The heating system includes an inlet conduit for circulating air from the HVAC system of the vehicle to the heat collector. The air is heated at the heat collector, and an outlet conduit circulates the heated air back to the HVAC system.

### BACKGROUND OF THE INVENTION

The present invention relates generally to exhaust gas conveyance systems and heating systems in vehicles. More specifically, the present invention relates to a heating system utilizing the exhaust gases from a vehicle's engine.

Exhaust gas conveyance systems on large vehicles frequently emit exhaust gases with extremely high temperatures. The high temperatures can be achieved from routine engine operation. Further, high temperatures can also be achieved during a regeneration event, where collected particulate matter that is trapped in the particulate filter is oxidized. At the high temperatures, objects located near the outlet of the exhaust gas conveyance system can be damaged.

Another problem with large vehicles is that their interior compartments are difficult to heat. Typically, the interior of the vehicle is heated by extracting heat from the vehicle's engine. However, in large automotive vehicles such as buses, this method is insufficient because the engine requires a prolonged amount of time to warm up. Frequently, the bus has to idle for upwards of 30-minutes before the engine is sufficiently warmed up, which consumes an excessive amount of fuel. Further, once the engine is warmed up, the amount of heat extracted from the engine is frequently insufficient to warm the large interior compartment.

The problem of slow engine warm-up and insufficient heating of the interior compartment has been addressed by adding fuel-fired heaters. Fuel-fired heaters are devices that take fuel from the fuel tank and which combust the fuel. The resulting heat is used to heat up the coolant, which in turn provides heat for the interior compartment. However, there are disadvantages to using fuel-fired heaters, including containing an open flame within the heater, providing a housing on the chassis for the heater, providing the fluid conduits to and from the heater, and the high cost of manufacture.

Heat exchangers are also sometimes added to the engine exhaust system to remove heat from the exhaust gas and transfer it to the water or coolant circuit. However, for larger vehicles, such as buses, the heat exchangers are insufficient because the normal engine exhaust temperatures are not high enough to adequately heat the large interior compartment.

Thus, there is a need for an exhaust gas conveyance system that can reduce the temperature of the exhaust gas.

There is also a need for a heating system that provides an adequate amount of heat to a large interior compartment.

### BRIEF SUMMARY OF THE INVENTION

The above-listed needs are met or exceeded by the present heating system for use on an exhaust system of a vehicle having an exhaust gas passageway to emit exhaust gases from an engine to an outlet includes a quasi black body heat collector. The heat collector is located on the exhaust gas passageway for capturing heat from the exhaust gases. The heating system includes an inlet conduit for circulating air from the HVAC system of the vehicle to the heat collector. The air is heated at the heat collector, and an outlet conduit circulates the heated air back to the HVAC system.

An alternate embodiment of a heating system for use on an exhaust system of a vehicle having an exhaust gas passageway to emit exhaust gases from an engine to an outlet includes a quasi black body heat collector. The heating system includes a particulate filter located on the exhaust gas passageway downstream of the engine. A quasi black body heat collector is located on the exhaust gas passageway downstream of the particulate filter for capturing heat from the exhaust gases. Also included is an inlet conduit for circulating air from the HVAC system of the vehicle to the heat collector. The air is heated at the heat collector. An outlet conduit circulates the heated air from the heat collector back to the HVAC system.

A quasi black body heat collector assembly for use on an exhaust system of a vehicle having an exhaust gas passageway to emit exhaust gases from an engine to an outlet includes a housing. The housing is configured to be connected to the exhaust system. A heat collector passageway extends through the housing for permitting the flow of exhaust gases through the housing. Also included is at least one tube disposed in the housing. An inlet conduit is fluidly connected to the tube and is configured for introducing air into the tube. The air is heated at the tube. An outlet conduit is fluidly connected to the tube and is configured for exiting the heated air from the housing to the HVAC system of the vehicle.

### BRIEF DESCRIPTION OF THE SEVERAL VIEWS OF THE DRAWINGS

FIG. 1 is a plan view of an exhaust conveyance system including a heating system of the present invention; and

FIG. 2 is a section view of a quasi black body heat collector of the heating system of FIG. 1.

### DETAILED DESCRIPTION OF THE INVENTION

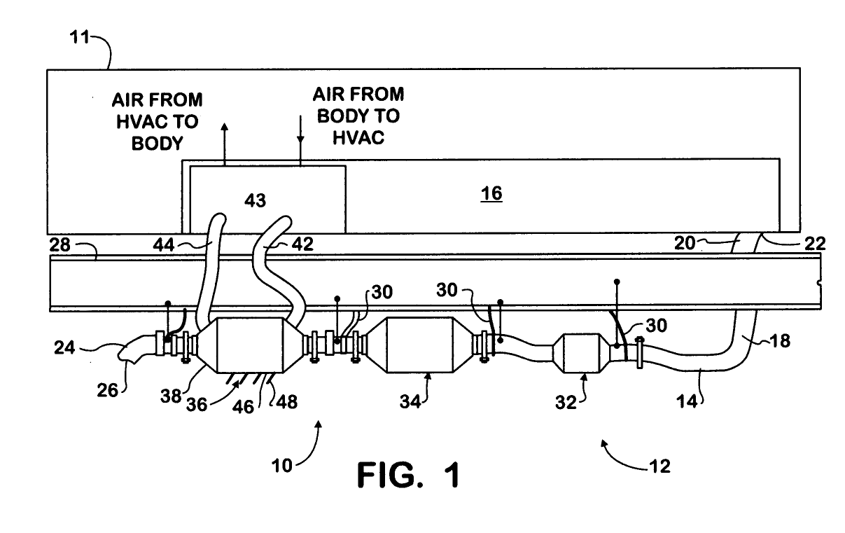

Referring now to FIG. 1, a heating system assembly is depicted generally at 10, and is disposed on an exhaust system assembly including an aftertreatment system, depicted generally at 12. The heating system 10 is configured for recovering waste heat from exhaust gases passing through the exhaust system assembly 12. While the following description is directed to an exhaust system 12 and a heating system assembly 10 for use with a bus 11, it is contemplated that this heating system can be used with other vehicles.

The exhaust system assembly 12 forms an exhaust gas passageway 14 for gases emitted from an engine 16. The passageway 14 is formed with an exhaust inlet pipe 18, having an inlet 20 connected to an exhaust outlet of the engine 22, and an exhaust outlet pipe 24, having an outlet 26 for venting the exhaust gases to the atmosphere. The heating system assembly 10 is located downstream of the exhaust inlet pipe 18 and upstream of the exhaust outlet pipe 24 in the direction of flow of the exhaust gases.

The exhaust system assembly 12 is preferably mounted on a chassis member 28 using conventional mounting structures 30. The exhaust system assembly 12 preferably extends longitudinally along the length of the bus.

In the direction of flow of the exhaust gases, the exhaust system assembly 12 incorporates aftertreatment devices, and specifically, includes an oxidation catalyst member 32 and a particulate filter 34. The oxidation catalyst member 32 is a conventional flow-through device that oxidizes unburned fuel and oil to reduce harmful emissions. Further, the particulate filter 34 is a conventional filter that removes particulate matter from the exhaust gases.

The heating system assembly 10 includes the exhaust system assembly 12, and also includes a quasi “black body” heat collector 36, which is disposed downstream of the particulate filter 34. The term “black body” refers to an ideal body that, if it existed, would have 100% absorption, 0% reflection, and 100% emission of all radiation that hits the body. While ideal black bodies are not known to exist, quasi black bodies are known bodies that approximate the behavior of an ideal black body. For example, certain materials, such as carbon in its graphite form, absorb 97% of the radiation that hit it. Additionally, it is also known to coat objects with paint that exhibits high absorption with transmittance and reflectance near zero for infrared energy.

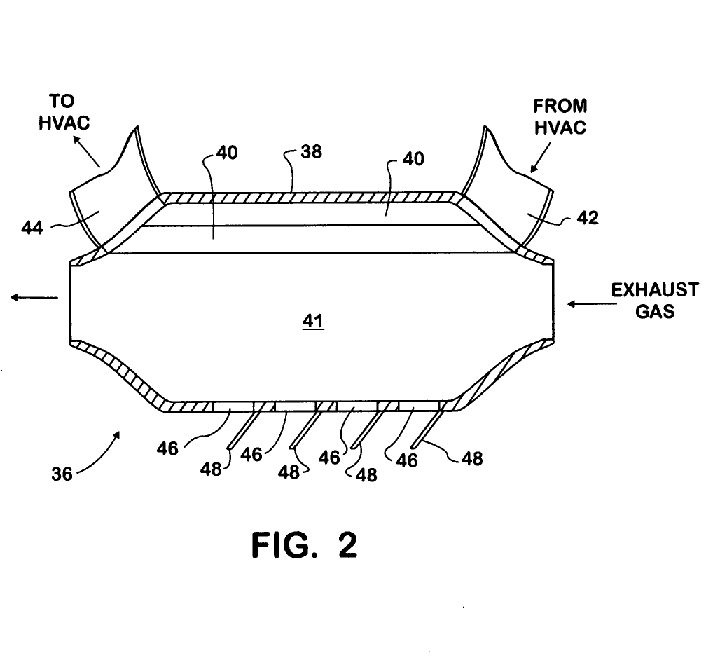

Referring now to FIGS. 1 and 2, the preferred embodiment of the quasi black body heat collector 36 includes a housing 38 and a plurality of tubes 40 extending through the housing. Further, a heat collector passageway 41 extends through the housing 38 and permits the flow of exhaust gases through the heat collector 36. The tubes 40 are preferably coated with a high absorption paint having a high temperature resistance. The tubes 40 of the heat collector 36 absorb the heat generated in exhaust system 12, and specifically, absorb the heat downstream of the particulate filter 34 as the exhaust gases flow through the heat collector passageway 41.

Extending to the heat collector 36 from the HVAC system 43 of the bus 11 is an inlet conduit 42. The inlet conduit 42 is in fluid connection with the tubes 40 of the heat collector 36. The blower motor of the HVAC system 43 forces air through the inlet conduit 42 and into the tubes 40 in the heat collector 36. In the tubes 40, the air is heated as it flows through the quasi black body heat collector 36. Then, the heated air exits the tubes 40 through an outlet conduit 44. The outlet conduit 44 is in fluid communication with the HVAC system 43 and permits the forced convection of heated air to the body or interior compartment of the bus 11.

While the present heating system assembly 10 includes one quasi black body heat collector 36 located downstream of the particulate filter 34, it is contemplated that a plurality of heat collectors can be located along the exhaust system 12. Further, while the preferred quasi black body heat collector 36 has a plurality of tubes 40 coated with high absorption paint, it is contemplated that the tubes can be made of materials exhibiting high absorption and emission of radiation.

When the temperature of the exhaust gases becomes too hot, the quasi black body heat collector 36 includes at least one port 46 and one port cover 48 that can be selectively opened and closed to draw in ambient air. Preferably, the ports 46 are located on the housing 38 of the heat collector 36 such that they provide fluid communication between the ambient and the exhaust gases. The ports 46 are configured in such that when they are opened, some of the exhaust gases are diverted to the environment thus reducing the exhaust gas mass flow, and hence, heat transfer to the tubes 40.

The port cover 48 is preferably hingeably attached to the port 46. Further, the port cover 48 and the materials surrounding the port 46 are preferably made of a ferromagnetic material such that the port cover is magnetically attracted to a closed position with respect to the port. In the preferred embodiment, when the temperature of the metals forming the heat collector 36 reach the Curie point, (i.e. the temperature at which a ferromagnetic material loses it's magnetization), the port cover 48 automatically swings open. That is, when the temperature reaches the Curie point, the port cover 48 is no longer attracted to the material surrounding the port 46, and the port cover opens. Alternatively, a controller, such as the engine controller unit (ECU) or a body controller (not shown), could automatically open the ports 46 when the temperature of the exhaust gases reaches a predetermined temperature.

While heat from the present heating system 10 is configured to supplement the heat conventionally derived directly from the engine 16, it is contemplated that the present heating system can completely substitute for the heat derived from the engine. Further, it is contemplated that the present heating system 10 can be used in combination with any other known heating systems.

While particular embodiments of the present heating system 10 have been shown and described, it will be appreciated by those skilled in the art that changes and modifications may be made thereto without departing from the invention in its broader aspects and as set forth in the following claims.

We claim:

1. A heating system for use on an exhaust system of a vehicle having an exhaust gas passageway to emit exhaust gases from an engine to an outlet, said vehicle having a HVAC system, comprising:
a quasi black body heat collector located on the exhaust gas passageway for capturing heat from the exhaust gases;
an inlet conduit for circulating air from the HVAC system to said quasi black body heat collector, wherein the air is heated at said quasi black body heat collector; and
an outlet conduit for circulating the heated air from said quasi black body heat collector back to the HVAC system.

2. The heating system of claim 1 wherein said quasi black body heat collector comprises a plurality of tubes coated with a high absorption paint or coating.

3. The heating system of claim 2 wherein said quasi black body heat collector comprises a housing around said plurality of tubes.

4. The heating system of claim 2 wherein said quasi black body heat collector comprises a heat collector passageway that permits the flow of exhaust gases through said quasi black body heat collector.

5. The heating system of claim 4 wherein said quasi black body heat collector comprises at least one port and at least one port cover hingeably attached to said at least one port.

6. The heating system of claim 5 wherein said at least one port is in fluid communication with said heat collector passageway, wherein when said at least one port cover is opened, exhaust gases are vented to the environment to reduce the heat transfer to said plurality of tubes.

7. The heating system of claim 5 wherein said at least one port is located on a housing of said quasi black body heat collector.

8. The heating system of claim 5 wherein said at least one port cover is made of a ferromagnetic material such that the port cover is magnetically attracted to a closed position with respect to said port.

9. The heating system of claim 8 wherein when the temperature of said quasi black body heat collector reaches its Curie point, said at least one port cover automatically opens.

10. The heating system of claim 1 further comprising a particulate filter located on the exhaust gas passageway downstream of the engine, wherein said quasi black body heat collector is located on the exhaust gas passageway downstream of said particulate filter.

11. The heating system of claim 1 further comprising multiple quasi black body heat collectors disposed along the exhaust gas passageway.

12. A heating system for use on an exhaust system of a vehicle having an exhaust gas passageway to emit exhaust gases from an engine to an outlet, said vehicle having a HVAC system, comprising:
a particulate filter located on the exhaust gas passageway downstream of the engine;
a quasi black body heat collector located on the exhaust gas passageway downstream of said particulate filter for capturing heat from the exhaust gases;
an inlet conduit for circulating air from the HVAC system to said quasi black body heat collector where the air is heated; and
an outlet conduit for circulating the heated air from said quasi black body heat collector back to the HVAC system.

13. The heating system of claim 12 wherein said quasi black body heat collector comprises a plurality of tubes coated with a high absorption paint or coating.

14. The heating system of claim 13 wherein said quasi black body heat collector comprises a housing around said plurality of tubes.

15. The heating system of claim 12 wherein said quasi black body heat collector comprises a heat collector passageway that permits the flow of exhaust gases through said quasi black body heat collector.

16. The heating system of claim 12 wherein said quasi black body heat collector comprises at least one port and at least one port cover hingeably attached to said at least one port.

17. A quasi black body heat collector assembly for use on an exhaust system of a vehicle having an exhaust gas passageway to emit exhaust gases from an engine to an outlet, said vehicle having a HVAC system, the heat collector assembly comprising:
a housing configured to be connected to said exhaust system;
a heat collector passageway extending through said housing for permitting the flow of exhaust gases through said housing;
at least one tube disposed in said housing;
an inlet conduit fluidly connected to said at least one tube and configured for introducing air into the tube where the air is heated; and
an outlet conduit fluidly connected to said at least one tube and configured for exiting the heated air from said housing to the HVAC system.

18. The quasi black body heat collector of claim 17 wherein said tube draws heat from the exhaust gases flowing through said heat collector passageway.

19. The quasi black body heat collector of claim 17 wherein said at least one tube is coated with high absorption paint or coating.

20. The quasi black body heat collector of claim 17 further comprising a port in fluid connection with said heat collector passageway and configured for venting exhaust gases from said passageway when the exhaust gases reach a predetermined temperature.
